(19) United States
(12) Patent Application Publication
(10) Pub. No.: US 2009/0136198 A1
(43) Pub. Date: May 28, 2009

(54) VIDEO REPRODUCING/RECORDING AND PLAYING SYSTEM AND METHOD FOR SETTING AND PLAYING VIDEO SECTION

(75) Inventors: Chung-Jen Chen, Taipei (TW); Meng-Tze Liu, Taipei (TW); Hung-Shen Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 12/177,402

(22) Filed: Jul. 22, 2008

(30) Foreign Application Priority Data
Nov. 28, 2007 (TW) 096145205

(51) Int. Cl. H04N 5/91

(52) U.S. Cl. 386/46

(57) ABSTRACT

A video reproducing/recording and playing system and a method thereof for setting and playing video sections are provided. The system includes a host computer with a data buffer and a database, a video module, and a monitor. While continuously receiving video signals, the video module sets a first section index when a scene difference between a first frame and a second frame represented by a portion of the video signals is greater than a predetermined scene difference wherein the first section index points to a start time of the second frame. Then, the video module stores the first section index and stores the video signals corresponding to the second frame into the data buffer. After retrieving the first section index, the monitor presents the video signals from the second frame points by the first section index.

### FIELD OF THE INVENTION

The present invention relates to a video reproducing/recording and playing system and a method for setting and playing video sections applied to the system, and more particularly to a system and method performing scene analysis in real-time play so as to provide section-selection function in time-shifting mode.

### BACKGROUND OF THE INVENTION

Nowadays, many electrical appliances are widely used with computers due to the amazing power of computers. For example, the TV signals of cable or wireless TV programs can be transmitted to the personal computer for display. Typically, the TV signals are transmitted to the personal computer by externally wiring a TV box to the computer or installing a TV tuner card in the computer and then communicating the TV box or TV tuner card with a TV signal input terminal. By such means, the TV programs can be displayed through the personal computer.

Please refer to FIG. 1A, which is a schematic circuit block diagram illustrating the configuration of displaying TV programs through a conventional computer system. As shown in FIG. 1A, the TV signals issued from a TV signal input terminal are received by a TV tuner card 14. After channel tuning, encoding/decoding, and format conversion are implemented by the TV tuner card 14, the processed signals are transmitted to a host computer 10 via a cardbus 16. Therefore, the TV programs can be presented in a frame window 18 shown on monitor 11 in communication with the host computer 10.

These TV tuner cards are also called as TV capture cards. When a TV capture card is applied to the computer system, a memory device such as a hard disc (HD) 101 of the host computer 10 can be utilized to store related data. In addition, some programs installed in the computer system can be used to edit or process the data. By operating an input device such as a mouse 12 or a keyboard (not shown), the video data corresponding to the TV signals can be presented on monitor 11 in real-time. Further, these video data can be captured, recorded, and stored in the computer system as video files.

For example, by executing an application program associated with the TV tuner card 14, the host computer 10 shows both the frame window 18 for presenting images and a user interface 180 on monitor 11 as shown in FIG. 1B. By operating the mouse 12 or other input device to select a function button of the user interface 180, the user may control playing, capturing or recording operations to the TV programs.

In addition to real-time playing and recording functions, the application program associated with the TV tuner card has time shifting function. By using the time-shifting function, the user can operate the time-shifting bar 182 of the user interface 180 to go back and play previous video segments while the TV tuner card still continuously receives and encodes/decodes the TV signals and performs the format conversion. Hence, in addition to watching broadcasting TV programs in real time, the user can replay previous segments or missed segments.

The principle of implementing the time-shifting function will be illustrated as follows. Firstly, when the TV tuner card performs the playing operation, the TV tuner card converts the video signals of the TV programs into digital data, and stores the digital data in the hard disc 101. In views of the great storage capacity of the hard disc 101, a data buffer is established in the hard disc 101. For example, upon executing the application program, a data buffer having a predetermined size is defined in the hard disc 101. The predetermined size is determined by the application program or pre-set in the device. The digital data corresponding to the TV program segments are temporarily stored in the data buffer while the monitor 10 continuously shows the TV program. That is, the TV program segments corresponding to the newly received TV signals are retained in the data buffer. The earliest TV program segments are overwritten when the total recorded segment size exceeds the predetermined size. In a case that the time-shifting function is activated, the recorded segments retained in the data buffer can be loaded or displayed as required.

As previously described, the time-shifting function allows the user to review the segments stored in the data buffer without affecting the continuous recording of the newly received signals into the data buffer. Hence, the host computer 10 can return to the normal playing state. This time-shift function, however, doesn't fully satisfy the playback requirements. For example, the video data aren't divided into sections in this stage. Therefore, the PREVIOUS button 184 and the NEXT button 186 of the user interface 180 are disabled and cannot be selected in the time-shifting mode. The only way that the user can search desired segments is operating the time-shifting bar 182.

In the time-shifting mode, the user cannot select the PREVIOUS button 184 and the NEXT button 186 to search desired segments or frames. It is inconvenient and time-consuming for the user to find out desired segments or frames in the time-shifting mode. An improvement in the prior art is desired.

### SUMMARY OF THE INVENTION

The present invention provides a video reproducing/recording and playing system and a method for setting and playing video sections. The system can perform scene analysis and divide the program into sections during the real-time display. Hence, section search is available in the time-shifting mode.

In accordance with an aspect of the present invention, there is provided a method for setting and playing video sections applied to a video reproducing/recording and playing system. The method includes steps of: continuously receiving video signals; setting a first section index when a scene difference between a first frame and a second frame represented by a portion of the video signals is greater than a predetermined scene difference wherein the first section index points to a start time of the second frame; storing the first section index; storing the video signals corresponding to the second frame into a data buffer of the video reproducing/recording and playing system; and retrieving the first section index and presenting the video signals from the second frame pointed by the first section index.

In accordance with another aspect of the present invention, there is provided a video reproducing/recording and playing system for setting and playing video sections. The system includes a host computer having a data buffer and a database; a video module in communication with the host computer; and a monitor. While continuously receiving video signals, the video module sets a first section index when a scene difference between a first frame and a second frame represented by a portion of the video signals is greater than a predetermined scene difference. Then, the video module stores the first section index in to the database and stores the video signals corresponding to the second frame into the data buffer. By executing an application program associated with the video module to show a user interface, a section search button such a PREVIOUS button and a NEXT button can be selected to have the monitor present the video signals from the second frame pointed by the first section index.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic circuit block diagram illustrating the configuration of a conventional computer system for displaying TV programs;

FIG. 1B is a schematic view illustrating a frame window and a user interface shown on monitor;

FIG. 2A is a schematic circuit block diagram illustrating the configuration of a computer system for displaying TV programs according to the present invention;

FIG. 2B is a schematic view illustrating a frame window and a user interface shown on monitor according to the present invention;

FIG. 3A schematically illustrates a first embodiment of a method for setting video sections according to the present invention;

FIG. 3B is a flow chart illustrating the steps of the method in FIG. 3A;

FIG. 4A schematically illustrates a second embodiment of a method for setting video sections according to the present invention; and

FIG. 4B is a flow chart illustrating the steps of the method in FIG. 4A.

### DETAILED DESCRIPTION OF THE PREFERRED EMBODIMENT

In the prior art, the PREVIOUS button and NEXT button of the user interface cannot be clicked on in the time-shifting mode. Search for specific video segments becomes inconvenient and time-consuming. The function of jumping to the previous or next section is disabled because the video data stored in the data buffer have not been divided into sections like commercial video discs.

In the prior art, the recorded program is processed and divided into several sections after the recording step so as to facilitate section search. For example, the sections are manually set by personal option or automatically set based on fixed time interval. However, in real-time play, it is inconvenient and time-consuming for the user to drag the tracking slider of the time-shifting bar to search desired sections. Furthermore, the hard disc 101 can only store video data with predetermined time length. If the user cannot timely find the desired video segment, the desired video segment is probably cleared for new incoming video data. Hence, the time-shifting function is somewhat dissatisfying.

The TV signals are stored as streaming data. In other words, the TV signals represent a plurality of frames. The frames are processed to have the same dimension and resolution so that the amount of pixels is equal in every frame. Continuous play of these frames shows the TV program. When the images vary, there is relation between color values of the pixels at the corresponding position (with the same coordinates) of sequential frames.

A motion detection technology is suggested to detect the pixels of sequential frames. In an embodiment, if the background, scene or object edge, even the main image or theme, in a video segment of the TV program doesn't vary too much, the pixels at corresponding position in a particular region of sequential frames may have the same color value or have little difference in color values. On the other hand, if the scene sharply changes between sequential frames, most of the pixels vary obviously. For example, the situation includes that bright frame is transformed into dark frame or an advertisement is inserted between the TV program segments. This scene analysis technology is also applied to MPEG compression to get a maximum compression ratio for video data with less sharp change so as to save storage space.

The present invention provides a method for setting video sections based on the scene analysis technology. There is distinct difference in color value or brightness of sequential frames when an advertisement appears or section transformation occurs. The distinct difference is detectable. Hence, the present invention provides a video reproducing/recording and playing system and a method for setting and playing video sections according to the concept. The system can perform scene analysis and divide the program into sections during the real-time display. Thus, a section search is available in the time-shifting mode.

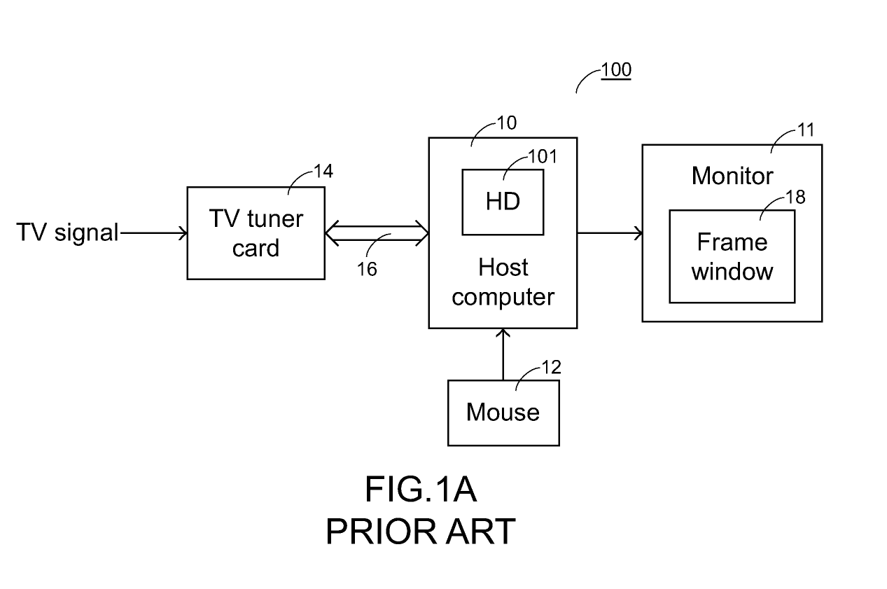

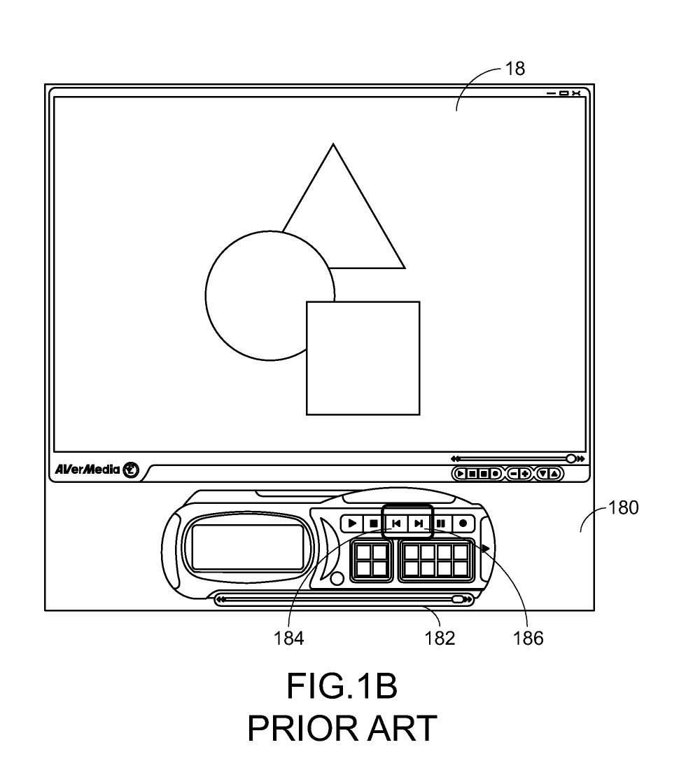

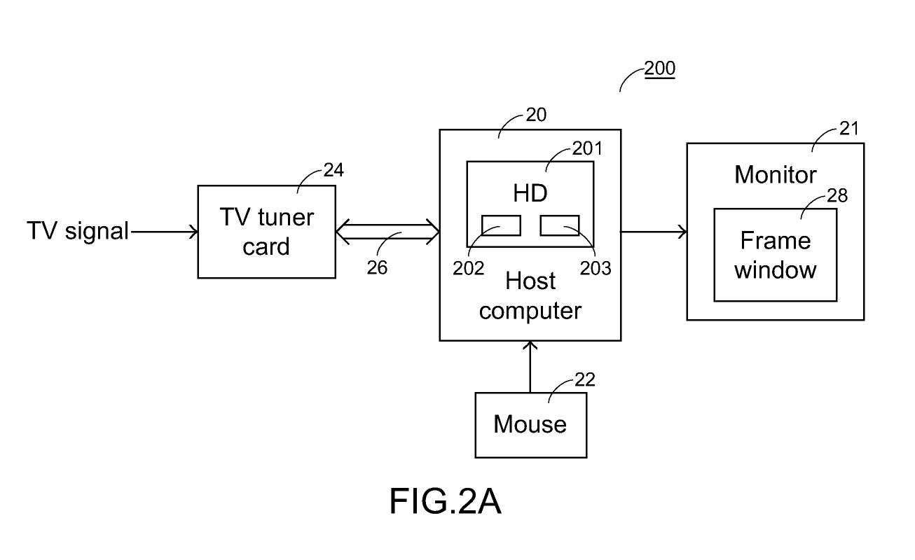

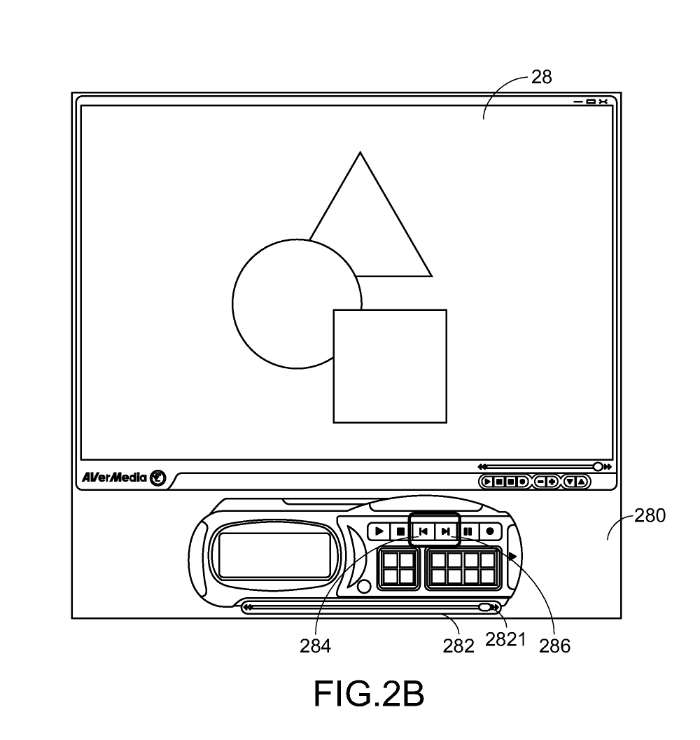

Please refer to FIG. 2A which is a schematic circuit block diagram illustrating the configuration of a computer system for displaying TV programs according to the present invention. In a preferred embodiment, the computer system 200 includes similar devices as those described with reference to FIG. 1A, including a host, a video module and a monitor 21. The video module is implemented by a TV tuner card 24 and the host is implemented by a host computer 20 in communication with the TV tuner card 24 and the monitor 21. The TV signals are received by the TV tuner card 24. After channel tuning, encoding/decoding, and format conversion are implemented by the TV tuner card 24, the processed signals are transmitted to the host computer 20 via a cardbus 26. Certainly, an application program associated with the TV tuner card 24 has been loaded into the hard disc 201 of the host computer 20.

By executing the application program, a frame window 18 and a user interface 280 are shown on monitor 21 as shown in FIG. 2B. The user interface 280 includes a time-shifting bar 282, a PREVIOUS button 284 and a NEXT button 286. By operating the mouse 22 or other input device, the images or frames representing the TV signals are shown in the frame window 28 in real time.

The TV tuner card 24 also supports time-shifting function. That is, the tracking slider 2821 can be moved along the time-shifting bar 282 to play back video segments. A database 202 and a data buffer 203 are provided in the hard disc 201 for storing section data and buffing the video data to be processed, respectively. The system and method of the present invention can finish setting sections during the real-time play. The present invention can be implemented by modifying the application program associated with the TV tuner card 24 or directly integrating related modules into the TV tuner card 24 to effectively achieve the function of setting sections. The principle is described in detail as follows.

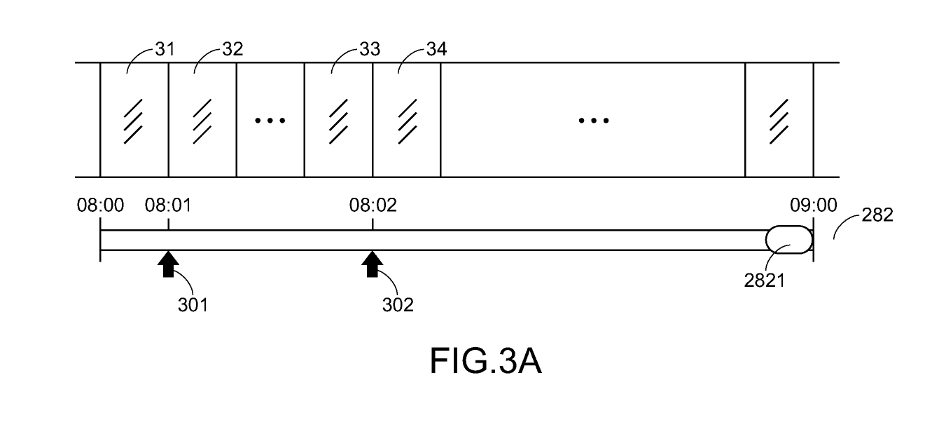

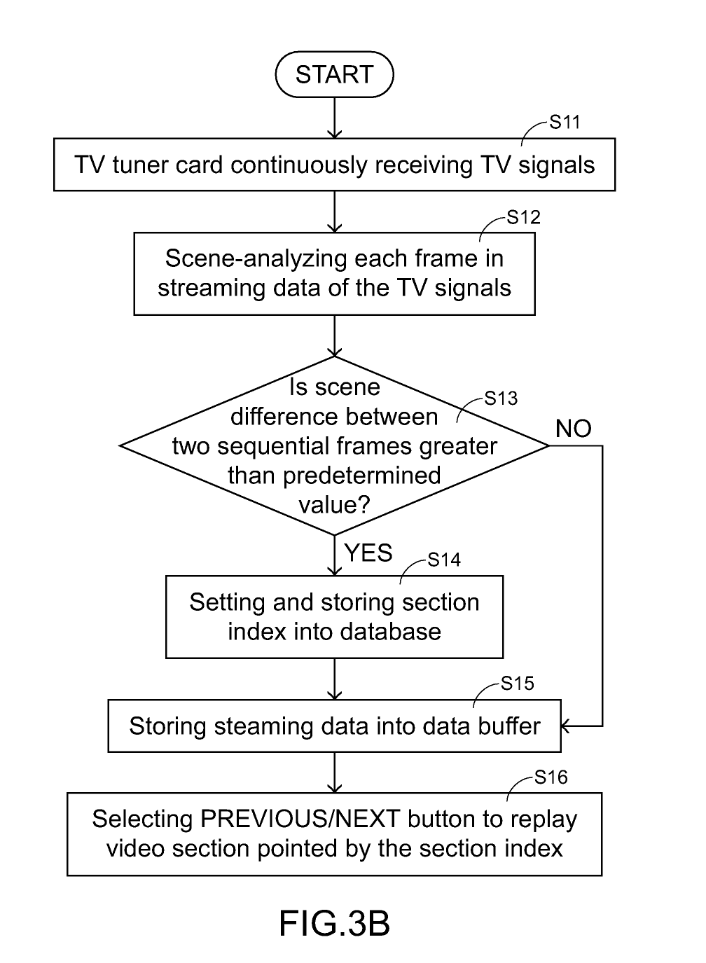

Please refer to FIG. 3A schematically illustrating a first embodiment of a method for setting video sections according to the present invention. The time length shown on the time-shifting bar 282 means the allowable size of the video data stored in the data buffer 203. In this embodiment, the time length is set as one hour. If one hour of video data have been stored in the data buffer 203 but new video data are still incoming, the video data corresponding to the newly received TV signals replace the earliest recorded video data in the data buffer 203 so that the data buffer 203 maintains one hour of the latest content of the TV program.

As shown in FIG. 3A, the tracking slider 2821 is positioned at current time (i.e. 09:00). In the time-shifting mode, the tracking slider 2821 can be moved to the left margin, which represents one hour ago (i.e. 08:00), to play back the TV program. Before the streaming data are stored into the data buffer 203, scene analysis is performed to analyze the frames in the streaming data to divide the contents into sections. In other words, the TV tuner card 24 starts scene analysis at 08:00.

In this embodiment, when the TV tuner card 24 detects that scene difference between a frame 31 and its next frame 32 is greater than a predetermined scene difference, a section index 301 is set to point to the position. The analysis concept has been described in the previous paragraph. The predetermined scene difference may include ratio of pixels which change in two sequential frames or color value variation of pixels in particular region between two sequential frames. Based on the predetermined scene difference, the video data can be properly divided into sections. The predetermined scene difference is determined by programmers of the application program or manufacturers of the TV tuner card 24.

Before the section index 301 is marked, the video data of the frame 31 are stored in the data buffer 203. In this embodiment, the frame 31 is the first frame and no previous frame can be stored. After the next frame 32 is analyzed, the section index 301 is stored into the database 202 and the video data of the frame 32 are stored into the data buffer 203. If there is no section index set in this step, the corresponding video data are directly stored into the data buffer 203.

In this embodiment, the section index 301 corresponds to the start time of the frame 32 (i.e. 08:01). At the same time, the PREVIOUS button 284 and NEXT button 286 of the user interface 280 are operable. Hence, the user can click the PREVIOUS button 284 or the NEXT button 286 for section search even though the TV tuner card 24 continues the real-time display. The TV tuner card 24 retrieves the section index 301 from the database 202 and accesses the video data from the data buffer 203 for playback of the video section from the frame 32 pointed by the section index 301.

In the real-time play and analysis step, more section indexes are set. Another example is given for sequential frames 33 and 34. In the analysis step, it detects that the scene difference between the frames 33 and 34 is greater than the predetermined scene difference so that another section index 302 is set to point to this position. Before the section index 302 is set, the steaming data corresponding to the frame 33 and the frames prior to the frame 33 are stored in the data buffer 203. After analyzing the scene in the frame 34, the section index 302 is stored in the database 202. Then, the streaming data corresponding to the frame 34 are stored in the data buffer 203. The section index 302 corresponds to the start time of the frame 34 (i.e. 08:02). The user can click on the PREVIOUS button 284 or the NEXT button 286 for section search. In this embodiment, the playback can start from 08:01 or 08:02, pointed by the section indexes 301 or 302.

Please refer to FIG. 3B which is a flow chart illustrating the steps of the method in FIG. 3A. At first, at step S11, the TV tuner card 24 continuously receives TV signals. Then, at step S12, the scene of each frame in streaming data of the TV signals is analyzed. At step S13, the system determines if the scene difference between two sequential frames is greater than a predetermined scene difference. If the scene difference is greater than the predetermined scene difference, a section index corresponding to the start time of the later frame is set and stored into the database 202 at step S14. Then, the streaming data are stored into the data buffer 203 at step S15. If the scene difference is not greater than the predetermined scene difference, the steaming data are directly stored into the data buffer 203 at step S15 without setting the section index. At last, at step S16, the user can select the PREVIOUS button 284 or the NEXT button 286 to select desired section index to replay desired section pointed by the section index at step S16.

As described above, in the first preferred embodiment, the section search function is enabled in the time-shifting mode. This video reproducing/recording and playing system and method improve the conventional system and method.

The method in the first embodiment facilitates section search by scene analysis. For some programs, the main image, theme background, or object edge, may have drastic change between frames. For example, the content of the program includes highly colorful and easily changeable scene. It increases difficulty of scene analysis and leads to too much division of the program. If many sections have a time length less than one minute, the database stores too many section indexes and it adversely affects the section search. It is found that the time interval between the frame 32 (i.e. 08:01) pointed by the first section index 301 and the frame 34 (i.e. 08:02) pointed by the second section index 302 is only one minute. Hence, it is reasonable that such section division isn't advantageous to the section search and the second section index 302 is not necessary.

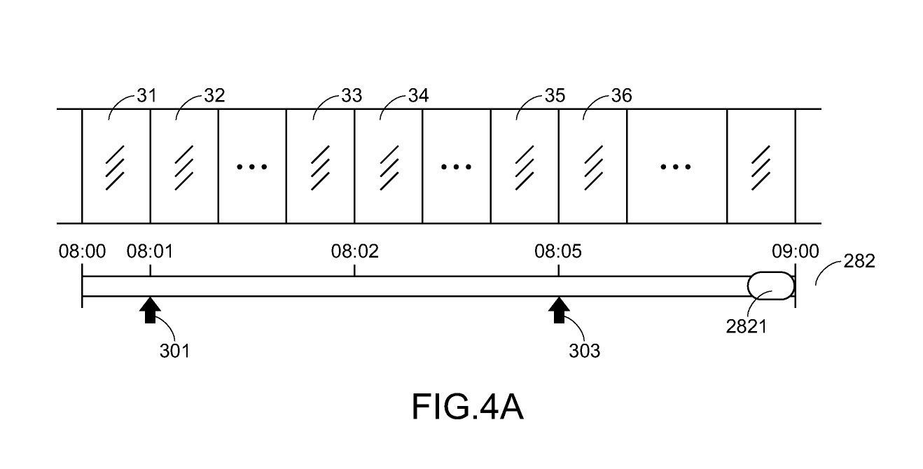

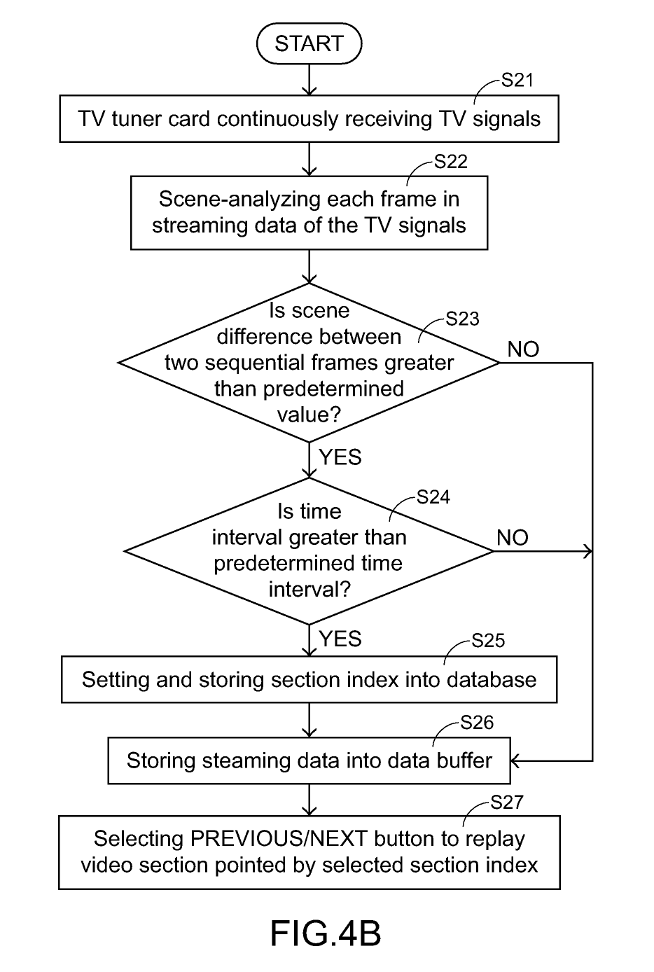

In order to prevent the improper division of the TV program, a second preferred embodiment is proposed. Please refer to FIG. 4A schematically illustrating the improved method for setting video sections according to the present invention. The section index 301 is set as described with reference to FIG. 3A. Further, a predetermined time interval is provided to properly divide the TV program. For example, the predetermined time interval is three minutes or other time interval value. When the section index 301 is set, the next section index doesn't is not set until the time interval between the two section indexes is greater than the predetermined time interval. In this embodiment, it is detected that the scene difference between the frames 35 and 36 is greater than the predetermined scene difference. Furthermore, the time interval between the start time of the frame 36 (i.e. 08:05) and that of the frame 32 pointed by the section index 301 exceeds the predetermined time interval, e.g. three minutes. Hence, another section index 303 points to the start time of the frame 36 can be set. The other steps are similar to the first embodiment and are not described again for concise purpose.

Please refer to FIG. 4B which is a flow chart illustrating the steps of the method in FIG. 4A. At first, at step S21, the TV tuner card 24 continuously receives TV signals. Then, at step S22, the scene of each frame in streaming data of the TV signals is analyzed. At step S23, the system determines if the scene difference between two sequential frames is greater than a predetermined scene difference. If the scene difference is greater than the predetermined scene difference, the procedure proceeds to the next determination step S24. At step S24, the system determines if the time interval between the frame pointed by the previous section index and currently analyzed frame is greater than the predetermined time interval. If yes, a section index is set and stored into the database 202 at step S25. Then, the streaming data are stored into the data buffer 203 at step S26. If the scene difference is not greater than the predetermined scene difference or the currently analyzed frame is too near the previous section index, the steaming data are directly stored into the data buffer 203 at step S26 without setting the section index. At last, at step 27, the user can select the PREVIOUS button 284 or the NEXT button 286 to select desired section index to replay desired section pointed by the section index.

According to the present invention, scene analysis technology is used for setting sections of TV program in real-time play. It solves the section search problem derived from the prior arts.

In the previously described embodiments, the present invention can be applied to TV signals including cable/wireless TV signals in digital/analog format. In fact, the present system and method can be applied to a video media such as video disc or video file stored in hard disc. The video module can be an optical disc player or an image processor and the application program can be any suitable video media player program. If there is no pre-set section index in the video media or video file for section search, the present method can work and set section indexes during a playback of the video media or video file. The processed data can be stored back to the disc media or stored as a new video file. Hence, the section search function is enabled for this video media or video file.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for setting and playing video sections applied to a video reproducing/recording and playing system, the method comprising steps of:
continuously receiving video signals;
setting a first section index when a scene difference between a first frame and a second frame represented by a portion of the video signals is greater than a predetermined scene difference wherein the first section index points to a start time of the second frame;
storing the first section index;
storing the video signals corresponding to the second frame into a data buffer of the video reproducing/recording and playing system; and
retrieving the first section index and playing the video signals from the second frame pointed by the first section index.

2. The method according to claim 1 wherein the video reproducing/recording and playing system comprises:
a host computer comprising the data buffer;
a video module for receiving the video signals; and
a monitor for displaying frames represented by the video signals.

3. The method according to claim 2 wherein the host computer comprises a database for storing the first section index.

4. The method according to claim 2, further comprising steps of:
showing a user interface with a function button for selecting a previous/next section by executing an application program; and
activating a time-shifting function for a playback of the video signals and presenting the video signals from the second frame when the function button is selected.

5. The method according to claim 2, further comprising steps of:
setting a second section index when a scene difference between a third frame and a fourth frame represented by another portion of the video signals is greater than a predetermined scene difference wherein the second section index points to a start time of the fourth frame and a time interval between the second frame and the fourth frame is greater than a predetermined time interval;
storing the second section index; and
storing the video signals corresponding to the fourth frame into the data buffer.

6. The method according to claim 5, further comprising a step of retrieving the second section index and presenting the video signals from the fourth frame pointed by the second section index.

7. The method according to claim 5, further comprising steps of:
showing a user interface with a function button for selecting a previous/next section by executing an application program; and
activating a time-shifting function for a playback of the video signals and presenting the video signals from one of the second frame and the fourth frame when the function button is selected.

8. The method according to claim 2, further comprising steps of:
setting a second section index when a scene difference between a third frame and a fourth frame represented by another portion of the video signals is greater than the predetermined scene difference;
storing the second section index; and
storing the video signals corresponding to the fourth frame into the data buffer.

9. The method according to claim 8 wherein the second section index points to a start time of the fourth frame so that the video signals are presented from the fourth frame when the second section index is selected.

10. The method according to claim 8, further comprising steps of:
showing a user interface with a function button for selecting a previous/next section by executing an application program; and
activating a time-shifting function for a playback of the video signals and presenting the video signals from one of the second frame and the fourth frame when the function button is selected.

11. A video reproducing/recording and playing system for setting and playing video sections, comprising:
a host computer comprising a data buffer;
a video module in communication with the host computer for continuously receiving video signals, setting a first section index when a scene difference between a first frame and a second frame represented by a portion of the video signals is greater than a predetermined scene difference, storing the first section index, and storing the video signals corresponding to the second frame into the data buffer; and
a monitor in communication with the host computer for displaying frames represented by the video signals,
wherein a user interface is shown on monitor by executing an application program associated with the video module and is operated to present the video signals from the second frame pointed by the first section index.

12. The video reproducing/recording and playing system according to claim 11 wherein the host computer comprises a database for storing the first section index.

13. The video reproducing/recording and playing system according to claim 11 wherein the first section index points to a start time of the second frame, the video reproducing/recording and playing system retrieving the first section index from the database and playing the video signals from the second frame pointed by the first section index.

14. The video reproducing/recording and playing system according to claim 13 wherein the user interface comprises a function button for selecting a previous/next section to give a playback of the video signals from the start time spot of the second frame.

15. The video reproducing/recording and playing system according to claim 11 wherein the video module sets a second section index when a scene difference between a third frame and a fourth frame represented by another portion of the video signals is greater than a predetermined scene difference and a time interval between the second frame and the fourth frame is greater than a predetermined time interval, stores the second section index into the database, and stores the video signals corresponding to the fourth frame into the data buffer.

16. The video reproducing/recording and playing system according to claim 15 wherein the user interface comprises a function button for selecting a previous/next section to give a playback of the video signals from one frame pointed by one of the first section index and the second section index.

17. The video reproducing/recording and playing system according to claim 11 wherein the video module sets a second section index when a scene difference between a third frame and a fourth frame represented by another portion of the video signals is greater than a predetermined scene difference, stores the second section index into the database, and stores the video signals corresponding to the fourth frame into the data buffer.

18. The video reproducing/recording and playing system according to claim 17 wherein the user interface comprises a function button for selecting a previous/next section to give a playback of the video signals from one frame pointed by one of the first section index and the second section index.

19. The video reproducing/recording and playing system according to claim 11 wherein the video signals are TV signals selected from ones of cable TV signals and wireless TV signals.

20. The video reproducing/recording and playing system according to claim 11 wherein the video signals are selected from ones of digital video signals and analog video signals obtained from a video file stored in a video media.
